(19) United States
(12) Patent Application Publication
(10) Pub. No.: US 2024/0066764 A1
(43) Pub. Date: Feb. 29, 2024

(54) METHOD FOR MANUFACTURING A SEAT PADDING, SEAT PADDING AS SUCH, AND SEAT AS SUCH

(71) Applicant: FAURECIA Sièges d'Automobile, NANTERRE (FR)

(72) Inventors: Mathieu CLUET, ETAMPES (FR); Benoît GAZANIOL, ARPAJON (FR)

(21) Appl. No.: 18/239,335

(22) Filed: Aug. 29, 2023

(30) Foreign Application Priority Data
Aug. 31, 2022 (FR) 2208739

(51) Int. Cl. B29C 43/00; B29C 43/18; B29C 48/00; B29C 70/22; B32B 3/04; B32B 5/02; B60N 2/70

(52) U.S. Cl. CPC B29C 43/006; B29C 43/18; B29C 48/0011; B29C 70/22; B32B 3/04; B32B 5/022; B60N 2/7017; B29K 2105/12; B32B 2250/02; B32B 2262/0284; B32B 2262/16; B32B 2307/72; B32B 2601/00; B32B 2605/003

(57) ABSTRACT

The present disclosure relates to a method for manufacturing a seat padding comprising:—/A/ providing a padding comprising a 3D entanglement of continuous thermoplastic fibers arranged irregularly forming loops welded together, the padding having a length direction, a width direction, and a thickness direction, as well as a border on the periphery extending along the edges of the padding—/B/ Hot pressing of the 3D entanglement of fibers, at all or part of the periphery of the padding, so as to produce a densified and stiffened border of the padding, relative to a central zone of the padding of less density and of less rigidity. The present disclosure also relates to padding as such, as well as to a vehicle seat comprising such padding.

### PRIORITY CLAIM

This application claims priority to French Patent Application No. FR2208739, filed Aug. 31, 2022, which is expressly incorporated by reference herein.

### BACKGROUND

The present disclosure relates to a method for manufacturing a seat padding as well as a seat comprising such padding and a lining attached to the padding.

### SUMMARY

According to the present disclosure, method for manufacturing a seat padding is proposed, comprising:
/A/ Providing a padding comprising a 3D entanglement of continuous thermoplastic fibers arranged irregularly, for example, randomly, forming loops welded together, the padding having a lengthwise direction, a widthwise direction and a thickness direction, as well as a border on the periphery extending along the edges of the padding,
/B/ Hot pressing of the 3D entanglement of fibers at all or part of the periphery of the padding, so as to produce a densified and stiffened border of the padding relative to a central zone of the padding of less density and of less rigidity.

The features disclosed in the following paragraphs can optionally be implemented independently of one another or in combination with one another:
the hot pressing in /B/ can generate a densified and stiffened border which is adjoined by a proximal end to the central zone of the padding, and having a free distal end, and wherein the densified and stiffened border extends along its thickness, over a portion of the thickness of the central zone, in length along the edge of the periphery, and in width, from its proximal end to its distal end,
and wherein the densified and stiffened border forms a shoulder with a free edge of the central zone of the padding

and wherein the method provides:
/C/ folding the densified and stiffened border against the free edge of the central zone.
the densified and stiffened border in /A/has a first face extending in line with one of the faces of the central portion of the padding.
the width dimension of the densified and stiffened border defined between the proximal end and the distal end is between 80% and 120% of the dimension of the thickness of the central zone, such as 100% of the thickness.
the step /A/ of providing can comprise:
/A1/ Extruding a thermoplastic polymer in an extrusion die comprising extrusion nozzles distributed in a lengthwise direction and along a widthwise direction of the extrusion die, generating a curtain of continuous molten fibers, falling by gravity,
/A2/ Receiving the curtain of continuous molten fibers falling by gravity onto one or more support elements with a generation of a 3D entanglement of fibers according to an irregular, for example, random, distribution with fusion of loops among the continuous fibers,
/A3/ optionally solidifying the 3D entanglement of fibers by immersion in a cooling liquid.
hot pressing over all or part of the periphery may result in a compression and partial reduction of the thickness of the 3D entanglement of at least 60%, or even at least 70%, or even at least 80%.

The method may have all or some of the following features
the fibers are hollow fibers and/or solid fibers, with a diameter of between 0.2 mm and 2 mm, preferentially between 0.3 mm and 1.5 mm,
the fibers comprise a thermoplastic polymer, the composition of the fibers comprising at least 95% by weight of PET,
and wherein the 3D entanglement of the padding has an apparent density of between 20 kg/m³ and 70 kg/m³, in particular between 45 kg/m³ and 65 kg/m³ outside the densified and stiffened zone(s).

According to another aspect, the present disclosure relates to a seat padding that can be obtained according to the method of the present disclosure comprising a 3D entanglement of continuous thermoplastic fibers arranged irregularly, for example, randomly, forming loops welded together between the fibers, and wherein:
the fibers are hollow fibers and/or solid fibers, in particular with a diameter of between 0.2 mm and 2 mm, preferentially between 0.3 mm and 1.5 mm,
the fibers comprise a thermoplastic polymer, the composition of the fibers comprising in particular at least 95% by weight of PET,
the padding comprising a densified and stiffened peripheral border obtained by hot pressing the 3D entanglement over all or part of the periphery
and wherein the 3D entanglement of the padding has an apparent density preferably between 20 kg/m³ and 70 kg/m³, in particular between 45 kg/m³ and 65 kg/m³ outside the peripheral densified and stiffened zones.

According to one embodiment of the padding, the densified and stiffened border is adjoined by an end proximal to the central zone of the padding of lower density, and has a free distal end, the densified and stiffened border being folded against a free edge of the central zone of the padding, by covering the free edge of the central zone.

According to another aspect, the present disclosure relates to a vehicle seat comprising:
a padding according to the present disclosure,
a lining covering the padding, the lining covering an upper surface of the padding, as well as a flank of the padding, the flank formed by the densified and stiffened border, folded against the free edge of the central zone of the padding.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a view of a motor vehicle seat, according to one embodiment, showing the metal structure of the seat supporting a plastic seat back interface intended to receive a plastic seat back padding layer and a plastic seat bottom interface, intended to receive a layer of seat bottom padding, the paddings of the seat back and seat bottom not being shown.

FIG. 2 is a cross sectional view of the seat of FIG. 1, on which a layer has been added of seat back padding and seat bottom padding, according to the present disclosure. comprising a random entanglement in three dimensions (3D) of continuous thermoplastic fibers comprising loops of fibers heat-welded to one another.

FIG. 3 is a schematic view of the manufacturing method for manufacturing the 3D entanglement comprising extruding a thermoplastic polymer in an extrusion die generating a curtain of continuous molten fibers, falling by gravity, receiving the curtain of continuous molten fibers between two counter-rotating guide members, with generation of a 3D entanglement of fibers and solidifying the 3D entanglement of fibers by immersion in a cooling liquid, and then obtaining padding through cuts transverse to the run direction.

FIG. 4 is a view of an edge of the padding obtained according to the method of FIG. 3, the edge having an irregular surface condition in particular when it results from transverse cuts according to the manufacturing method shown in FIG. 3.

FIG. 5 a view of a first mold M1, a second mold M2 making it possible to obtain stiffened and densified borders, by thermoforming the borders, resulting in a partial reduction of the thickness EP of the 3D entanglement of at least 60%, or even of at least 70%, or even of at least 80%.

FIG. 6 is: on the right, a view of the padding after hot pressing and forming two densified and stiffened borders, on the left, a detail view of one of the stiffened and densified borders that is adjoining a central portion of the padding by a proximal end, and terminated by a free distal end, the stiffened and densified border extending one of the faces of the padding, the stiffened and densified border being obtained by a reduction in thickness of the 3D entanglement, relative to a central portion, the stiffened and densified border forming a shoulder with the central portion, the shoulder formed between the stiffened and densified border and a free edge of the central portion.

FIG. 7 is a detail view of FIG. 6 with: on the left, after folding at 90° of the stiffened border against the free edge of the central portion, on the right, after folding at 90° of the stiffened border and placing a lining.

FIG. 8 is a view of a seat according to another embodiment comprising a suspension associated with the seat bottom structure and a suspension associated with the seat back structure.

FIG. 9 is a view of an assembly comprising a padding and a support associated with the padding.

### DETAILED DESCRIPTION

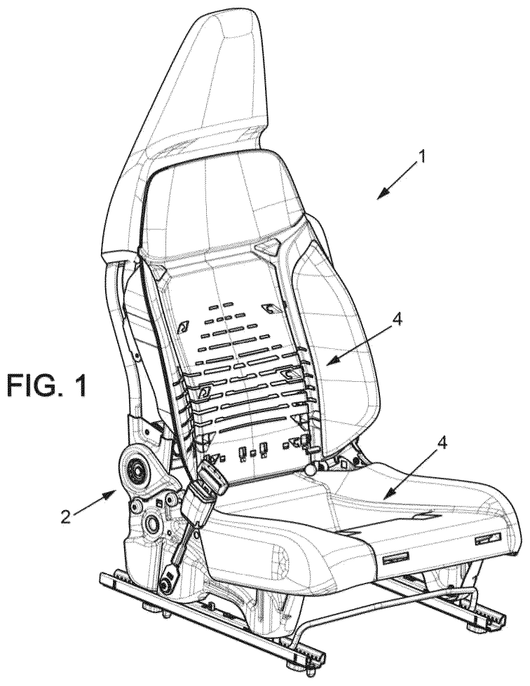

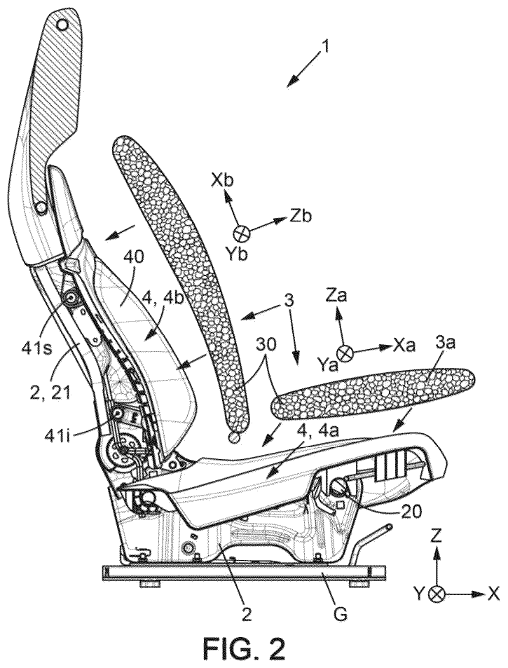

Also, the present disclosure relates to a seat 1 comprising:
a structure 2, for example, metallic,
a padding 3.
optionally an interface 4 located between the structure 2 and the padding 3, and in particular as shown according to the embodiment of FIGS. 1 and 2.

The seat also, for example, comprises a lining CF (not shown in FIG. 1) covering the padding 3, being, for example, attached to the padding.

In FIG. 2, a reference frame XYZ is shown, the direction X oriented along the sliding direction of the slide G between the seat structure 2 and a floor of the vehicle, the direction Y, oriented along a transverse direction of the seat, and the direction Z along the vertical

The structure 2, for example, made of metal, comprises a seat bottom frame 20 and a seat back frame 21, for example, articulated around a transverse axis of rotation, for example, by means of articulations of the continuous type.

The seat bottom frame 20, for example, comprises:
two lateral flanges, extending from a rear edge of the seat bottom and to a front edge, along the direction X, or slightly inclined relative to the longitudinal direction X (for example by plus or minus 30 degrees) around a transverse axis and,
a front part connecting two front ends of the flanges and extending in the transverse direction. The front part and the flanges are, for example, of sheet metal, shaped for example by stamping techniques.

The seat back frame, for example, comprises lateral uprights, extending upwards, as well as an upper cross member connecting two upper ends of the uprights. The uprights and the upper cross-member are, for example, of sheet metal, shaped for example by stamping techniques.

The padding 3, for example, comprises a seat bottom padding layer 3a which confers the comfort to the seat and which is received on a seat bottom interface 4a inserted between the seat bottom frame 20 and the seat bottom padding layer 3a and/or the padding 3, for example, comprises a seat back padding layer 3b which confers the comfort of the seat back and which is received on a seat back interface 4b which is inserted between the seat back frame 21 and the seat back padding layer 3b.

The padding 3, in particular the seat bottom padding layer 3a and/or the seat back padding layer 3b, comprises a three-dimensional (“3D”) entanglement of continuous thermoplastic fibers 5, arranged irregularly, for example, randomly, forming loops welded together between the fibers 5.

The fibers may be hollow fibers and/or solid fibers. The fibers may have a diameter comprised between 0.2 mm and 2 mm, preferentially between 0.3 mm and 1.5 mm. “Continuous,” as in “continuous fibers,” means the fact that the fibers have a length much greater than the diameter of the fibers, and because of the method which is described below, for example, at least a ratio of 100, or even 500, or even 1000. Very often, and in particular as understandable from the manufacturing method, the fibers, for example, extend from a first end to a first edge of the 3D entanglement and to a second end on a second edge of the entanglement AD, opposite the first edge.

The fibers 5 comprise a thermoplastic polymer, the composition of the fibers preferably comprising at least 95% by weight of PET. For example, the composition of the fibers, or even the padding, comprises:
95% to 99% by weight of a first polymer of the family of polyesters such as PET (polyethylene terephthalate),
1% to 5% by weight of a second polymer of the family of polyesters, such as PTT (polyethylene terephthalate) or PBT (polybutylene terephthalate). The sum of the PET and of the PTT (or PBT) can be 100% by weight of the fibers, or even of the padding. The 3D entanglement of the padding 5 may have an apparent density of between 20 kg/m³ and 70 kg/m³, or even between 45 kg/m³ and 65 kg/m³.

Preferably, the voids between the fibers 5 of the 3D entanglement of fibers 5 of the padding 3 are left open. A very breathable padding is obtained, because of the numerous interspaces (voids) between the fibers that promote air circulation.

The seat bottom padding layer 3a, extends lengthwise in a longitudinal direction Xa of the seat bottom from a rear edge to a front edge of the seat bottom, and in width along a transverse direction of the seat bottom from a first lateral edge to a second lateral edge, as well as thickness along an orthogonal direction Za, which is orthogonal to the longitudinal direction and to the transverse direction of the seat bottom. The thickness of the seat bottom padding layer may be between 60 mm and 100 mm.

The seat back padding layer 3b extends lengthwise in a longitudinal direction Xb of the seat back from a lower edge toward an upper edge of the seat back, and widthwise along a transverse direction Yb of the seat back from a first lateral edge to a second lateral edge, as well as thickness along an orthogonal direction Zb which is orthogonal to the longitudinal direction and the transverse direction of the seat back. The thickness of the seat back padding layer may be 15 mm to 50 mm.

The interface 4, in particular the seat bottom interface 4a or the seat back interface 4b, may comprise a material that is entirely or partially made of plastic. For example, the interface 4 is made of ABS (acrylonitrile butadiene styrene) and/or PC (polycarbonate) and/or P/E (polypropylene/polyethylene copolymer).

In general, the interface 4, in particular the seat bottom interface 4a or the seat back interface 4b, may comprise a shell. The shell may be a molded part or a thermoformed part.

In particular, the seat back interface 4b may comprise, as shown in FIG. 2:
at least one seat back deformable shell 40, receiving the padding, which is a seat back padding 3b, the deformable shell 40 being configured to take different shapes in particular from an initial position of lumbar lordosis and in particular to a final position of lumbar cyphosis, in response to a variable load applied by the back of the occupant of the seat,
a system coupling the deformable seat back shell 40 to the structure comprising upper movement control links 41s, and lower movement control links 41i.

The upper movement control links 41s and/or the lower movement control links 41i are, for example, articulated links which can comprise connecting rods.

According to another embodiment, the padding 8, in particular of seat bottom and seat back, can be associated with a seat structure, which comprises a, for example, metallic suspension SUP, in particular as shown in FIG. 8:
a, for example, metal suspension SUP connecting a front spacer and a rear spacer of a seat structure, the spacers connecting a right flange and a left flange of the seat structure,
a, for example, metal suspension SUP connecting a right upright and a left upright of a seat back structure.

Also, according to another embodiment, the padding can be associated with a support ST, for example, preassembled with the padding, and which in particular allows an assembly to a seat structure, for example, with no interface or suspension.

The present disclosure relates to a method for manufacturing a seat padding 3 comprising:
/A/ Providing a padding 3 comprising a 3D entanglement of continuous thermoplastic fibers 5, arranged irregularly (for example randomly) forming loops welded together, the padding having a length direction Xa, Xb, A width direction Ya,; Yb and a thickness direction Za, Zb as well as a periphery on the edges of the padding
/B/ Hot pressing of the 3D entanglement of fibers, on all or part of the periphery of the padding, so as to produce a densified and stiffened border Bdr of the padding, with a density greater than a central zone of the padding of less density and less rigidity.

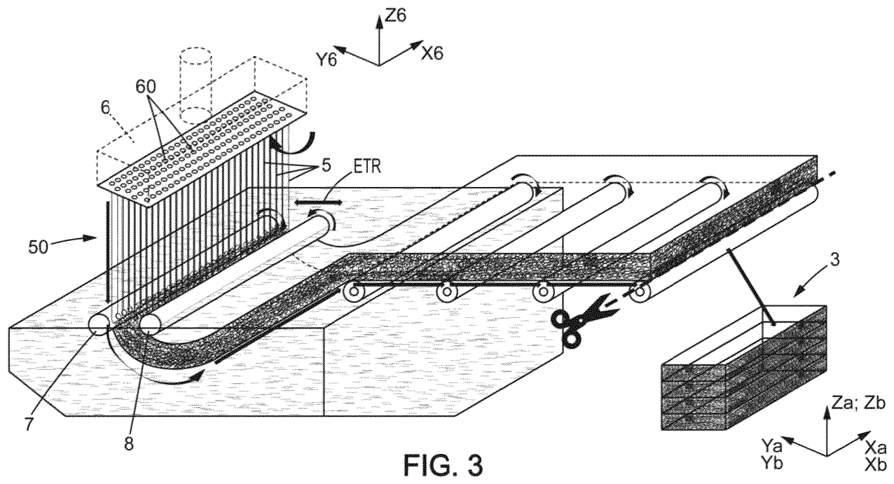

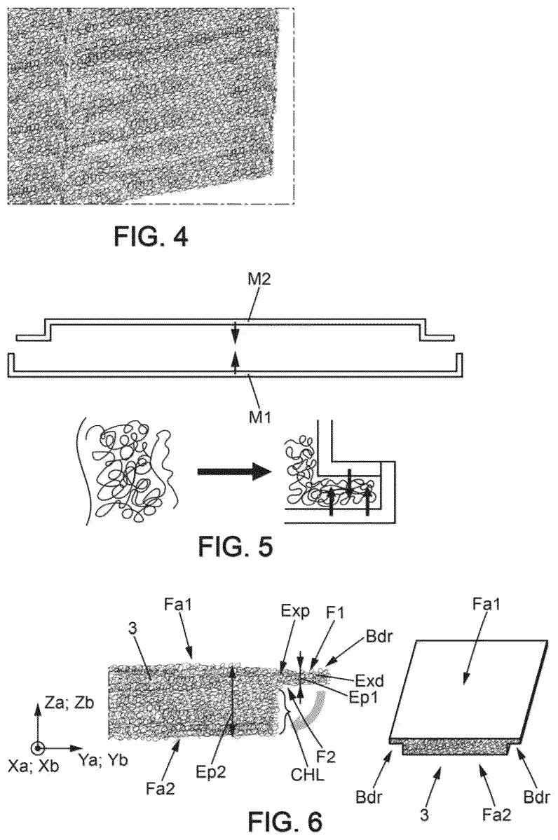

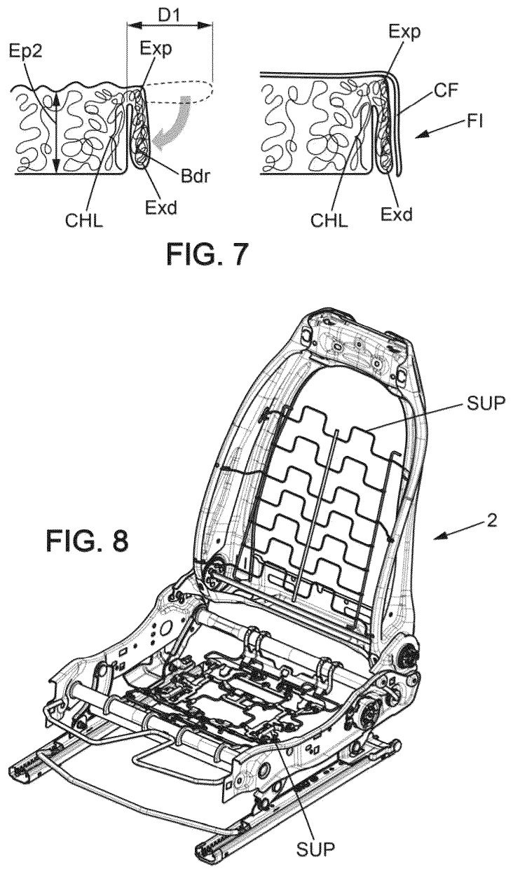

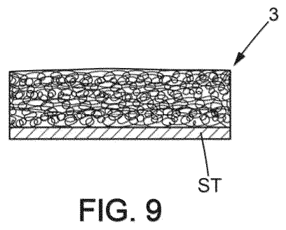

The step of providing /A/ may comprise, in particular as shown schematically in FIG. 3:
/A1/ Extruding a thermoplastic polymer in an extrusion die 6 comprising extrusion nozzles 60 distributed in a length direction X6 and along a width direction Y6 of the extrusion die, generating a curtain of continuous molten fibers 50, falling by gravity,
/A2/ Receiving the curtain of continuous molten fibers falling by gravity onto one or more support members, in particular between two counter-rotating guide members 7, 8, with a generation of a 3D entanglement of fibers 5 according to an irregular distribution, in particular random, with fusion of the loops between the continuous fibers, in particular according to a layer of thickness determined by the center distance ETR between the two counter-rotating members 7, 8
/A3/ Solidifying the 3D entanglement of fibers by immersion in a cooling liquid 9, such as water.

The extrusion nozzles 60 are preferably distributed regularly along the length direction X6 of the extrusion die, as well as along the width direction Y6.

The thickness of the padding layer formed by the entanglement can be adjusted, by adjusting the center distance between the two guide members 7, 8.

In /A2/, the two guide members 7, 8 are driven in rotation at a speed, lower than the speed of fall of the fibers, providing an accumulation of the fibers at the origin of the formation of loops that are welded together between fibers, generating the irregular or random entanglement in three dimensions. The solidification in /A/ is obtained just after step/B/, the two guide members being able to be immersed to mid-height, for this purpose.

The extrusion temperature implemented in /A/ in the extrusion die is, for example, between 180° C. and 240° C. The extrusion die is fed with granules of thermoplastic polymer.

The 3D entanglement layer of fibers, continuously running, is then guided out of the cooling liquid reservoir to be dried, for example, by shaking/vibrations. The running layer is then cut, by transverse cuts, making it possible to obtain different paddings 3, and as can be seen in FIG. 3. These paddings 3 extend lengthwise, for example lengthwise along the longitudinal direction Xa of the seat bottom padding layer (or in length along the longitudinal direction Xb of the seat back padding layer), for example, along the direction transverse to the running of the layer.

As an alternative to the continuous method shown in FIG. 3, a variant can be implemented wherein the padding is obtained comprising a 3D entanglement of continuous thermoplastic fibers arranged irregularly, for example, randomly forming loops welded together by:
/A1/ Extruding a thermoplastic polymer in an extrusion die comprising extrusion nozzles distributed along a lengthwise direction and along a width direction of the extrusion die, generating a curtain of continuous molten fibers, falling by gravity,
/A2/ Receiving the curtain of continuous molten fibers falling by gravity into a molding cavity of mold tooling so as to generate a 3D entanglement of fibers according to an irregular or random distribution with loops fusing between the continuous fibers
/A3/ Solidifying the 3D entanglement of fibers shaped in the mold cavity by immersion in a cooling liquid.

According to one embodiment, the nozzles are controllable, configured so as to be able to change the shape of the fiber curtain, and wherein a logic processing unit is provided which comprises a control module comprising a microprocessor and a memory comprising instructions for, in /A1/, controlling the nozzles so as to generate a curtain of molten fibers of variable shape during the extrusion along the length direction and/or the width direction of the extrusion die.

According to one embodiment, in particular according to the method of FIG. 3, the apparent density can be homogeneous along the length and width of the layer. The density of the number of extrusion nozzles is thus homogeneous along the length direction of the extrusion die. According to another embodiment, it is possible to have different zones of different apparent densities.

The padding obtained at the end of the method shown in FIG. 3, or generally, can generate a padding with a 3D entanglement of the padding 3 that has an apparent density of between 20 kg/m³ and 70 kg/m³, in particular between 45 kg/m³ and 65 kg/m³, and substantially homogeneous or not. Such padding density is configured to provide comfort and support of the occupant.

The edges of the padding obtained according to the method of FIG. 3 are not calendered, and even result, for example, from cuts, in particular transverse. These edges have a non-attractive surface condition, even when the edge is covered by a lining. Indeed, when the lining is stretched over an edge having an irregular surface condition, the flexible lining reproduces the surface irregularities of the edge. Step /B/ of the manufacturing method according to the present disclosure makes it possible to address this problem.

Hot pressing on all or part of the periphery results in a compression and partial reduction of the thickness EP of the 3D entanglement by at least 60%, or even at least 70%, or even at least 80% depending on the thickness.

Hot pressing is, for example, carried out at a temperature between 160° C. and 190° C., at least at the periphery of the padding. Hot pressing is, for example, a thermoforming step, during which the padding is applied under pressure between a first mold M1 and a second mold M2.

In general, and as seen in FIG. 6, hot pressing in /B/ generates a densified and stiffened border Bdr, which is adjoined by a proximal end Exp to the central zone of the padding, and which has a free distal end Exd. The densified and stiffened border Brd in /A/has a first face F1 preferably extending in extension of one of the two faces Fa1, Fa2 of the central portion of the padding 3, such as for example an upper face of the padding. The second face F2 is offset, that is, it does not extend either of the two faces Fa1, Fa2 of the central portion of the padding.

The densified and stiffened border Brd extends along its thickness EP1, over a portion of the thickness EP2 of the central zone. The thickness EP1 of the stiffened and densified border is, for example, less than 50% of the thickness EP2 of the central portion, or even less than 40%, or even less than 30% of the thickness EP1 of the central portion. The densified and stiffened border Brd extends lengthwise along the edge of the periphery, and widthwise, from its proximal end Exp to its distal end Exd.

In general, and as shown in FIG. 6, the densified and stiffened border Brd obtained in /B/ forms a shoulder with a free edge CHL of the central zone, of the padding. Free edge CHL of the central zone of the padding is understood to mean the portion of the edge of the central zone that is not adjacent to the stiffened and densified border Brd, and which is therefore visible at the end of the hot pressing step/B/.

According to one embodiment of the method, step /B/ can be followed by:
/C/ the folding of the densified and stiffened border Brd against the free edge CHL of the central zone.

The stiffened and densified border Brd is folded by folding around its proximal end Exp, for example, around the length direction of the stiffened and densified border. The densified and stiffened border Brd is folded, in particular substantially at 90°, so as to cover the free edge CHL of the central portion of the padding.

In particular, and for this purpose, the width dimension D1 of the densified and stiffened border Brd delimited between the proximal end Exp and the distal end Exd can represent between 80% and 120% of the dimension of the thickness EP2 of the central zone. In particular, the dimension D1 can, for example, represent 100% of the thickness EP2.

According to one embodiment, the method may comprise all or part of the following features:
the fibers are hollow fibers and/or solid fibers, with a diameter of between 0.2 mm and 2 mm, preferentially between 0.3 mm and 1.5 mm,
the fibers 5 comprise a thermoplastic polymer, the composition of the fibers comprising at least 95% by weight of PET,
the 3D entanglement of the padding 5 has an apparent density between 20 kg/m³ and 70 kg/m³, in particular between 45 kg/m³ and 65 kg/m³, in particular outside the densified and stiffened zone(s).

The present disclosure also relates to a seat padding that can be obtained according to the method according to the present disclosure, the padding comprising a 3D entanglement of continuous thermoplastic fibers 5, for example, arranged randomly, forming loops welded together between the fibers, and wherein:
the fibers are hollow fibers and/or solid fibers, in particular with a diameter of between 0.2 mm and 2 mm, preferentially between 0.3 mm and 1.5 mm,
the fibers 5 comprise a thermoplastic polymer, the composition of the fibers comprising in particular at least 95% by weight of PET.

According to the present disclosure, the padding comprises a densified and stiffened peripheral border obtained by hot pressing the 3D entanglement over all or part of the periphery.

The 3D entanglement of the padding 3 has an apparent density, for example, between 20 kg/m³ and 70 kg/m³, in particular between 45 kg/m³ and 65 kg/m³ outside the densified and stiffened zones, in particular peripheral zones. The apparent density of the densified and stiffened areas may be greater than 100 kg/m³, by way of example between 150 kg/m³ and 300 kg/m³.

Preferably, the densified and stiffened border Bdr is adjoined by a proximal end Exp to the central zone of the padding of lower density, and has a free distal end Exd, the densified and stiffened border being folded against a free edge CHL of the central zone of the padding, by covering the free edge CHL of the central zone.

The present description relates to a vehicle seat comprising:
a padding 3 according to the present disclosure
a lining CF covering the padding, the lining covering an upper surface of the padding, as well as a flank Fl of the padding, the flank formed by the densified and stiffened border Brd, folded against the free edge CHL of the central zone of the padding.

The densified and stiffened border Brd, thus folded, advantageously has a regular surface condition guaranteeing an irregularity-free appearance of the flank Fl when the edge Bdr is covered by the lining.

The present disclosure relates to the field of motor vehicle seats which comprise, for example, a metal structure, for example, with a seat bottom frame and a seat back frame. The structure may be obtained by stamping techniques. The seats further comprise padding, including a layer of seat bottom padding and a layer of seat back padding that impart the softness of the seat bottom and the seat back, and participate in comfort in the seat. These paddings are covered by linings covering the padding and which can, for example, be attached to fastening inserts, internal to the padding.

Comparative seat and back padding may be made of urethane polymer foam and are shaped in molds. The comparative polyurethane padding may be covered with a lining. Fastening inserts used for fastening the lining are trapped within the foam by overmolding. The comparative polyurethane foam paddings may retain moisture in humid conditions.

The present disclosure improves the situation.

A method for manufacturing a seat padding is proposed, comprising:
/A/ Providing a padding comprising a 3D entanglement of continuous thermoplastic fibers arranged irregularly, for example, randomly, forming loops welded together, the padding having a lengthwise direction, a widthwise direction and a thickness direction, as well as a border on the periphery extending along the edges of the padding,
/B/ Hot pressing of the 3D entanglement of fibers at all or part of the periphery of the padding, so as to produce a densified and stiffened border of the padding relative to a central zone of the padding of less density and of less rigidity.

The features disclosed in the following paragraphs can optionally be implemented independently of one another or in combination with one another:
the hot pressing in /B/ can generate a densified and stiffened border which is adjoined by a proximal end to the central zone of the padding, and having a free distal end, and wherein the densified and stiffened border extends along its thickness, over a portion of the thickness of the central zone, in length along the edge of the periphery, and in width, from its proximal end to its distal end,
and wherein the densified and stiffened border forms a shoulder with a free edge of the central zone of the padding
and wherein the method provides:
/C/ folding the densified and stiffened border against the free edge of the central zone.
the densified and stiffened border in /A/ has a first face extending in line with one of the faces of the central portion of the padding.
the width dimension of the densified and stiffened border defined between the proximal end and the distal end is between 80% and 120% of the dimension of the thickness of the central zone, such as 100% of the thickness.
the step /A/ of providing can comprise:
/A1/ Extruding a thermoplastic polymer in an extrusion die comprising extrusion nozzles distributed in a lengthwise direction and along a widthwise direction of the extrusion die, generating a curtain of continuous molten fibers, falling by gravity,
/A2/ Receiving the curtain of continuous molten fibers falling by gravity onto one or more support elements with a generation of a 3D entanglement of fibers according to an irregular, for example, random, distribution with fusion of loops among the continuous fibers,
/A3/ optionally solidifying the 3D entanglement of fibers by immersion in a cooling liquid.
hot pressing over all or part of the periphery may result in a compression and partial reduction of the thickness of the 3D entanglement of at least 60%, or even at least 70%, or even at least 80%.

The method may have all or some of the following features
the fibers are hollow fibers and/or solid fibers, with a diameter of between 0.2 mm and 2 mm, preferentially between 0.3 mm and 1.5 mm,
the fibers comprise a thermoplastic polymer, the composition of the fibers comprising at least 95% by weight of PET,
and wherein the 3D entanglement of the padding has an apparent density of between 20 kg/m³ and 70 kg/m³, in particular between 45 kg/m³ and 65 kg/m³ outside the densified and stiffened zone(s).

According to a second aspect, the present disclosure relates to a seat padding that can be obtained according to the method of the present disclosure comprising a 3D entanglement of continuous thermoplastic fibers arranged irregularly, for example, randomly, forming loops welded together between the fibers, and wherein:
the fibers are hollow fibers and/or solid fibers, in particular with a diameter of between 0.2 mm and 2 mm, preferentially between 0.3 mm and 1.5 mm,
the fibers comprise a thermoplastic polymer, the composition of the fibers comprising in particular at least 95% by weight of PET,
the padding comprising a densified and stiffened peripheral border obtained by hot pressing the 3D entanglement over all or part of the periphery
and wherein the 3D entanglement of the padding has an apparent density preferably between 20 kg/m³ and 70 kg/m³, in particular between 45 kg/m³ and 65 kg/m³ outside the peripheral densified and stiffened zones.

According to one embodiment of the padding, the densified and stiffened border is adjoined by an end proximal to the central zone of the padding of lower density, and has a free distal end, the densified and stiffened border being folded against a free edge of the central zone of the padding, by covering the free edge of the central zone.

According to a third aspect, the present disclosure relates to a vehicle seat comprising:
a padding according to the present disclosure,
a lining covering the padding, the lining covering an upper surface of the padding, as well as a flank of the padding, the flank formed by the densified and stiffened border, folded against the free edge of the central zone of the padding.

The present disclosure relates to a method for manufacturing a seat padding (3) comprising:
/A/ Providing a padding (3) comprising a 3D entanglement of continuous thermoplastic fibers (5) arranged irregularly forming loops welded together, the padding having a length direction, a width direction, and a thickness direction, as well as a border on the periphery extending along the edges of the padding
/B/ Hot pressing of the 3D entanglement of fibers, at all or part of the periphery of the padding, so as to produce a densified and stiffened border (Bdr) of the padding, relative to a central zone of the padding of less density and of less rigidity.

The present disclosure also relates to padding as such, as well as to a vehicle seat comprising such padding.

1. A method for manufacturing a seat padding comprising:
providing a padding comprising a 3D entanglement of continuous thermoplastic fibers arranged irregularly forming loops welded together, the padding having a lengthwise direction, a widthwise direction and a thickness direction, as well as a border on the periphery extending along the edges of the padding
hot pressing of the 3D entanglement of fibers, at all or part of the periphery of the padding, so as to produce a densified and stiffened border of the padding, relative to a central zone of the padding of less density and of less rigidity.

2. The method of claim 1, wherein the hot pressing generates a densified and stiffened border which is adjoined by a proximal end to the central zone of the padding, and having a free distal end, and wherein the densified and stiffened border extends along its thickness, over a portion of the thickness of the central zone, lengthwise along the edge of the periphery, and widthwise from its proximal end to its distal end,
and wherein the densified and stiffened border forms a shoulder with a free edge of the central zone of the padding
and wherein the method further provides:
folding of the densified and stiffened border against the free edge of the central zone.

3. The method of claim 2, wherein the densified and stiffened border has a first face extending in line with one of the faces of the central portion of the padding.

4. The method of claim 2, wherein the width dimension of the densified and stiffened border delimited between the proximal end and the distal end is between 80% and 120% of the dimension of the thickness of the central zone, such as 100% of the thickness.

5. The method of claim 1, wherein the providing step of providing comprises:
extruding a thermoplastic polymer in an extrusion die comprising extrusion nozzles distributed in a lengthwise direction and in a widthwise direction of the extrusion die, generating a curtain of continuous molten fibers, falling by gravity,
receiving the curtain of continuous molten fibers by gravity onto one or more support members with generation of a 3D entanglement of fibers according to an irregular distribution with fusion of loops between the continuous fibers, and/or
solidifying the 3D entanglement of fibers by immersion in a cooling liquid.

6. The method of claim 1, wherein the hot pressing on all or part of the periphery results in a partial compression and reduction of the thickness of the 3D entanglement by at least 60%, or even of at least 70%, or even of at least 80%.

7. The method of claim 1, having all or part of the following features
the fibers are hollow fibers and/or solid fibers, with a diameter of between 0.2 mm and 2 mm, preferentially between 0.3 mm and 1.5 mm,
the fibers comprise a thermoplastic polymer, the composition of the fibers comprising at least 95% by weight of PET,
and wherein the 3D entanglement of the padding has an apparent density of between 20 kg/m³ and 70 kg/m³, in particular between 45 kg/m³ and 65 kg/m³ outside the densified and stiffened zone(s).

8. A seat cushion obtained according to the method of claim 1, comprising a 3D entanglement of continuous thermoplastic fibers arranged irregularly, forming loops welded together between the fibers, and wherein:
the fibers are hollow fibers and/or solid fibers, in particular with a diameter of between 0.2 mm and 2 mm, preferably between 0.3 mm and 1.5 mm,
the fibers comprise a thermoplastic polymer, the composition of the fibers comprising in particular at least 95% by weight of PET,
the padding comprising a densified and stiffened peripheral border obtained by hot-pressing the 3D entanglement over all or part of the periphery and wherein the 3D entanglement of the padding has an apparent density of between 20 kg/m³ and 70 kg/m³ in particular between 45 kg/m³ and 65 kg/m³ outside the peripheral densified and stiffened areas.

9. The padding of claim 8, wherein the densified and stiffened border is adjoined by a proximal end to the central zone of the lower density padding, and has a free distal end, the densified and stiffened border being folded against a free edge of the central zone of the padding, by covering the free edge of the central zone

10. A vehicle seat comprising:
the padding according to claim 9
a lining covering the padding, the lining covering an upper surface of the padding, as well as a flank of the padding, the flank formed by the densified and stiffened border, folded against the free edge of the central zone of the padding.
